(19) United States
(12) Patent Application Publication
(10) Pub. No.: US 2005/0286580 A1
(43) Pub. Date: Dec. 29, 2005

(54) Heat-conducting member, laser diode attachment auxiliary member, optical head using the same, and optical recording/reproducing apparatus using the same

(75) Inventor: Teiichiro Oka, Tokyo (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 11/167,332

(22) Filed: Jun. 28, 2005

(30) Foreign Application Priority Data
Jun. 29, 2004 (JP) 2004-190857
Aug. 24, 2004 (JP) 2004-243779

(51) Int. Cl. H01S 3/04

(52) U.S. Cl. 372/36

(57) ABSTRACT

The invention relates to a heat-conducting member to conduct heat generated in a laser diode, an optical head using the same, and an optical recording/reproducing apparatus using the same, and has an object to provide a heat-conducting member to conduct heat generated in a laser diode. Besides, the invention has an object to provide an optical head in which various characteristics such as optical characteristics and electric characteristics are stable, and a lifetime of a laser diode can be prolonged, and an optical recording/reproducing apparatus using the same. A laser diode is fixed to a housing of an optical head by using a holder. A heat-conducting member is disposed between a base part of the laser diode and an FPC electrically connected to electrode terminals of the laser diode. The heat-conducting member functions to conduct heat generated in a light emitting part of the laser diode (heat conduction) and to release the heat to the holder for holding the laser diode and to the housing.

### BACKGROUND OF THE INVENTION

1. Field of the Invention

The present invention relates to a heat-conducting member to conduct heat generated in a laser diode, an optical head using the same, and an optical recording/reproducing apparatus using the same.

2. Description of the Related Art

FIG. 13 shows a partial cross section of the vicinity of a laser diode (light source) 103 of a conventional optical head 101 (the laser diode 103 is shown without being cut). In FIG. 13, the laser diode 103 is not cut and the whole is shown. As shown in FIG. 13, the laser diode 103 includes a light emitting part 103c to emit a light beam to be incident on an optical recording medium, and electrode terminals 103d, 103e and 103f connected to a power supply terminal to the light emitting part 103c and to a reference potential terminal. The electrode terminals 103d, 103e and 103f are formed to project from a base part 103b with a thin plate cylindrical shape. The electrode terminals 103d and 103f are disposed on a plane including a center axis of the base part 103b to be opposite to each other while a predetermined interval is provided with respect to the center axis, and the electrode terminal 103e is disposed on a plane including the center axis and vertical to the former plane while a predetermined interval from the center axis is provided. A cap 103a covering the light emitting part 103c is fixed on the base part 103b. The cap 103a includes a not-shown emission port through which the light beam is emitted.

In general, the laser diode 103 is attached to an opening provided in a housing 105 from the outside of the housing 105 of the optical head 101, and the emission port of the optical beam formed in the cap 103a is disposed toward the inside of the housing 105. The electrode terminals 103d, 103e and 103f are disposed toward the outside of the housing 105.

A holder 107 for holding the laser diode 103 is made of a conductive metal material, and has an opening 109 for avoiding the electrode terminals 103d, 103e and 103f. In the event that the holder 107 comes in contact with the electrode terminals 103d, 103e and 103f, there is a fear that serious trouble is caused in the optical head 101 by a short circuit. Thus, the opening 109 is formed to be sufficiently large so that it does not come in contact with them. The opening 109 at the housing 105 side is formed to be recessed by the thickness of the base part 103b. When the holder 107 on which the laser diode 103 is mounted is fixed by inserting the cap 103a to the opening of the housing 105, the base part 103b is sandwiched between the housing 105 and the holder 107. By this, the laser diode 103 is fixed to the housing 105. The holder 107 is fixed to the housing 105 by using a screw or an adhesive (neither of them is not shown).

Although not shown, there is also known an optical head 101 with such a structure that a housing 105 side is formed to be recessed by the thickness of a base part 103b, a laser diode 103 is directly fitted in the housing 105, a holder 107 is disposed from a side opposite to an emission direction of a light beam of the laser diode 103 (side of electrodes 103d, 103e and 103f), and the laser diode 103 is fixed to the housing 105. Besides, there is also a case where a laser diode 103 is fixed to a housing 105 by deforming (squeezing) the housing 105 or by using an adhesive.

The electrode terminals 103d, 103e and 103f projecting from the opening 109 of the holder 107 are soldered to a flexible printed circuit board (hereinafter abbreviated to an FPC) 35 by solders 39. By this, the laser diode 103 is connected to a power supply circuit (not shown) through the FPC 35.

In the optical head 101 for recording/reproduction, it is requested that a light spot for recording/reproduction condensed on an optical recording medium is made to have a better shape. Thus, in order to adjust the position of a light emitting point of the laser diode 103 and the emission direction of the laser light emitted from the laser diode 103, the laser diode 103 is often attached to the housing 105 while the position and tilt are adjusted through the holder 107.

The holder 107 and the housing 105 function also as a heat sink to release heat generated from the laser diode 103. Especially in the recordable optical head 101, since a high intensity light beam is generated at the time of recording, the heat quantity from the laser diode 103 is large, and importance is attached to thermal conduction and heat radiation so that a metal material is used for the holder 107 or the housing 105. Also in the laser diode 103, the light emitting part 103c as the heat generating part is provided on a mount integrated with the base part 103b of the metal material, and heat is efficiently conducted to the base part 103b. Since the metal material is a conductive material, the holder 107 and the housing 105 have such shape and structure that they are in contact with the laser diode 103 through only the cap 103a and the base part 103b, and are not in contact with the electrode terminal 103d and the like. In general, the electrode terminal 103d or the like is formed to be very close to the light emitting part 103c as the heat generating part of the laser diode 103.

[Patent document 1] JP-A-2003-272208

[Patent document 2] JP-A-2004-103084

[Patent document 3] JP-A-2004-111507

As stated above, the opening 109 is provided in the holder 107 so that it does not come in contact with the electrode terminal 103d or the like. Besides, in order that the laser diode 103 is not damaged by heat at the time of soldering to the FPC 35, a predetermined gap is provided between the base part 103b and the FPC 35. Most of the heat generated in the light emitting part 103c is released from the base part 103b. However, the opening 109 is a cavity, and is filled with the air. The thermal conductivity of the air is as very small as 0.0241 (W/m·K) at 0° C. Thus, as indicated by arrows of broken lines in FIG. 13, heat generated in the light emitting part 103c is conducted to the holder 107 and the housing 105 through the base part 103b, and heat conducted to the holder 107 through the opening 109 is very small. As stated above, since the path of heat conduction is limited, the heat generated in the light emitting part 103c is not sufficiently released, and various characteristics such as optical characteristics and electric characteristics of the laser diode 103 are changed, so that the performance of the optical head 101 is deteriorated, and its lifetime is shortened.

Patent document 1 discloses an optical pickup in which a thermal conductive resin is interposed between a laser diode and an adjacent part adjacent thereto, and a laser diode is fixed to a pickup base. However, when the resin is used for heat release, there is a possibility that a gap is produced between the laser diode and the adjacent part by contraction at the time of resin hardening. Besides, according to the resin used, gas is generated at the time of hardening, and there is a possibility that other parts are badly influenced by the gas. Further, it is necessary that the resin to be filled has high viscosity so that it does not drip or leak through a gap, and it takes much time to discharge/fill such a liquid agent, and therefore, the workability is poor.

### SUMMARY OF THE INVENTION

An object of the invention is to provide a heat-conducting member which efficiently conducts heat generated in a laser diode.

Besides, another object of the invention is to provide an optical head in which various characteristics such as optical characteristics and electric characteristics are stable and the lifetime of a laser diode can be prolonged, and an optical recording/reproducing apparatus using the same.

The above object is achieved by a heat-conducting member made of an insulating material and including a first contact part in thermal contact with a base part of a laser diode, a second contact part in thermal contact with a holder to hold the laser diode, and a hollow part formed to surround electrode terminals projecting from the base part.

The heat-conducting member of the above invention is characterized in that the insulating material is a ceramic material.

The heat-conducting member of the above invention is characterized in that the ceramic material is aluminum nitride.

The heat-conducting member of the above invention is characterized in that the insulating material is silicone rubber.

The heat-conducting member of the above invention is characterized in that the first contact part can come in close contact with the base part.

The heat-conducting member of the above invention is characterized in that the second contact part can come in close contact with the holder.

The heat-conducting member of the above invention is characterized in that the hollow part is formed to collectively surround the plural electrode terminals projecting from the base part.

The heat-conducting member of the above invention is characterized in that the hollow part is formed to surround each of the plural electrode terminals projecting from the base part.

Besides, the above object is achieved by an optical head including a laser diode to emit a laser light to an optical recording medium, a housing to fix the laser diode, a holder to hold laser diode, and a heat-conducting member including a first contact part in thermal contact with a base part of the laser diode, a second contact part in thermal contact with the holder, and a hollow part formed to surround an electrode terminal projecting from the base part.

The optical head of the above invention is characterized in that the heat-conducting member is made of an insulating material.

The optical head of the above invention is characterized in that the heat-conducting member is held between a printed circuit board electrically connected to the electrode terminal and the base part.

The optical head of the above invention is characterized in that the heat-conducting member is held between the base part and the holder.

The optical head of the above invention is characterized in that the heat-conducting member is in thermal contact with a vicinity of a heat generating part of the laser diode.

Besides, the above object is achieved by an optical recording/reproducing apparatus including the optical head of the invention.

According to the invention, heat generated in the laser diode is sufficiently released by using the heat-conducting member excellent in heat conductivity, and it is possible to realize the optical head in which various characteristics such as optical characteristics and electric characteristics of the laser diode are improved, and its lifetime is prolonged, and the optical recording/reproducing apparatus using the same.

### BRIEF DESCRIPTION OF THE DRAWINGS

FIGS. 1A and 1B are views showing an optical head 1 according to embodiment 1-1 of the invention;

FIGS. 2A and 2B are views showing the vicinity of a laser diode 3 of the optical head 1 according to the embodiment 1-1 of the invention;

FIGS. 3A and 3B show a first and a second modified examples of the optical head 1 according to the embodiment 1-1 of the invention and are views showing a heat-conducting member 37 when viewed from a side of a first contact part 37a;

FIG. 4 is a view showing the vicinity of a laser diode 3 of an optical head 1 according to embodiment 1-2 of the invention;

FIG. 5 is a view showing the vicinity of a laser diode 3 of an optical head 1 according to embodiment 1-3 of the invention;

FIGS. 6A and 6B are views showing an optical head 2 according to embodiment 2-1 of the invention;

FIGS. 7A and 7B are views showing the vicinity of a laser diode 3 of an optical head 2 according to the embodiment 2-1 of the invention;

FIGS. 8A and 8B show a first and a second modified examples of the optical head 2 according to the embodiment 2-1 of the invention and are views showing an attachment auxiliary member 34 when viewed from the side of a first and a second contact parts 34a and 34b;

FIG. 9 is a view showing the vicinity of a laser diode 3 of an optical head 2 according to embodiment 2-2 of the invention;

FIG. 10 is a view showing the vicinity of a laser diode 3 of an optical head 2 according to embodiment 2-3 of the invention;

FIG. 11 is a view showing the vicinity of a laser diode 3 of an optical head 2 according to embodiment 2-4 of the invention;

FIG. 12 is a view showing a rough structure of an optical recording/reproducing apparatus according to the embodiments 1-1 to 2-4 of the invention; and

FIG. 13 is a view showing the vicinity of a laser diode 103 of a conventional optical head 101.

### DETAILED DESCRIPTION OF THE INVENTION

### Embodiment 1-1

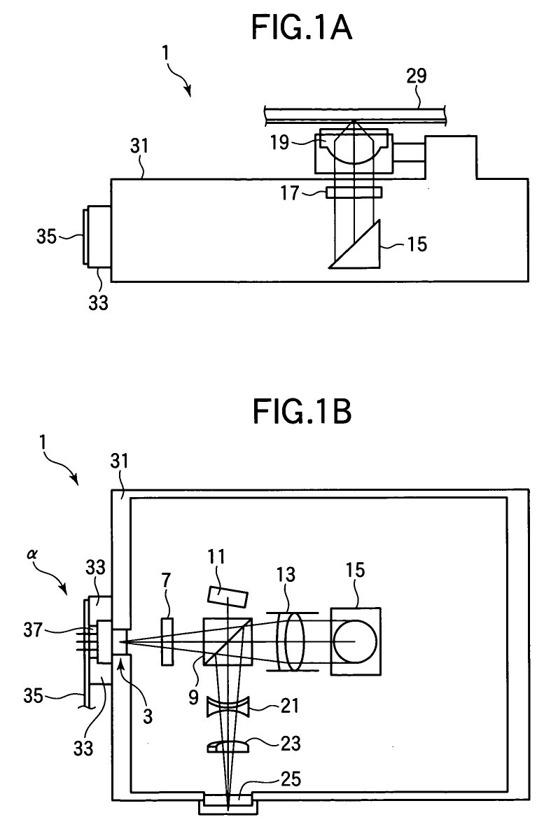

A heat-conducting member according to embodiment 1-1 of the invention and an optical head using the same will be described with reference to FIGS. 1A to 3B. First, a rough structure of an optical head according to this embodiment will be described with reference to FIGS. 1A and 1B. FIG. 1A shows an optical head 1 of this embodiment and a part of an optical recording medium 29, and shows a section cut by a plane orthogonal to an information recording surface of the optical recording medium 29 and parallel to a tangential direction of a truck of the optical recording medium 29. For facilitating understanding, a rising mirror 15 and a quarter wavelength plate 17 are transparently shown, which are disposed in a housing 31 and can not be originally seen. FIG. 1B shows a state in which a laser diode 3 and an optical system disposed in the housing 31 are seen in a direction vertical to the information recording surface of the optical recording medium 29, and for facilitating understanding, the quarter wavelength plate 17 disposed in the housing 31 is omitted in the drawing.

The structure and operation of an optical element group will be described with reference to FIGS. 1A and 1B. A light beam emitted from the laser diode 3 as a light source passes through a diffraction grating 7 and is converted into three beams for tracking error detection, and they are incident on a beam splitter 9. The beam splitter 9 has such polarization characteristics that 90% or more of light of P polarization is transmitted, and almost 100% of light of S polarization is reflected. The outward light beam in this embodiment has the P polarization, and most of it passes through the beam splitter 9, and several % of reflected light is incident on a front monitor optical detector 11, and the output of the laser diode 3 is controlled based on its output.

Most of the light beam having passed through the beam splitter 9 is incident on a collimate lens 13. The collimate lens 13 can be moved in the direction parallel to the optical axis. In the case where a spherical aberration added to the light beam condensed on the information recording surface of the optical recording medium 29 is different from a reference value by the thickness of the light transmission layer of the optical recording medium 29, the collimate lens 13 is moved in the optical axis direction, so that the spherical aberration can cancel out.

The light beam after transmission through the collimeter lens 13 is reflected by the rising mirror 15, and its optical path is bent toward the direction of the optical recording medium 29, and further, the light beam passes through the quarter wavelength plate 17 and is made a condensed light incident on the optical recording medium 29 by an objective lens 19. The quarter wavelength plate 17 has a function to convert the outward light beam into circular polarization and to convert the light beam of the circular polarization, which has been reflected by and returned from the optical recording medium 29, into linear polarization in the direction orthogonal to the polarization direction of the outward light beam.

The light beam, which has been condensed to form a spot on the information recording surface in the optical recording medium 29 and reflected, returns in a return path to the beam splitter 9 along the same path. Since the light beam having returned to the beam splitter 9 has S polarization by the action of the quarter wavelength plate 17, it is reflected.

The light beam after reflection is incident on a concave lens 21. At the time of assembling and adjusting the optical head 1, the concave lens 21 is moved in the optical axis direction, so that an image point position in the optical axis direction in the vicinity of a light receiving surface in an optical detector 25 as a light receiving element can be adjusted. The light beam having passed through the concave lens 21 passes through a cylindrical lens 23 so that astigmatism is given for focus error detection, and the beam is incident on the light detector 25. The concave lens 21 and the cylindrical lens 23 may be replaced with an anamorphic lens having functions of both. The light beam incident on the light detector 25 is converted into an electric signal by its inside inner light receiving part.

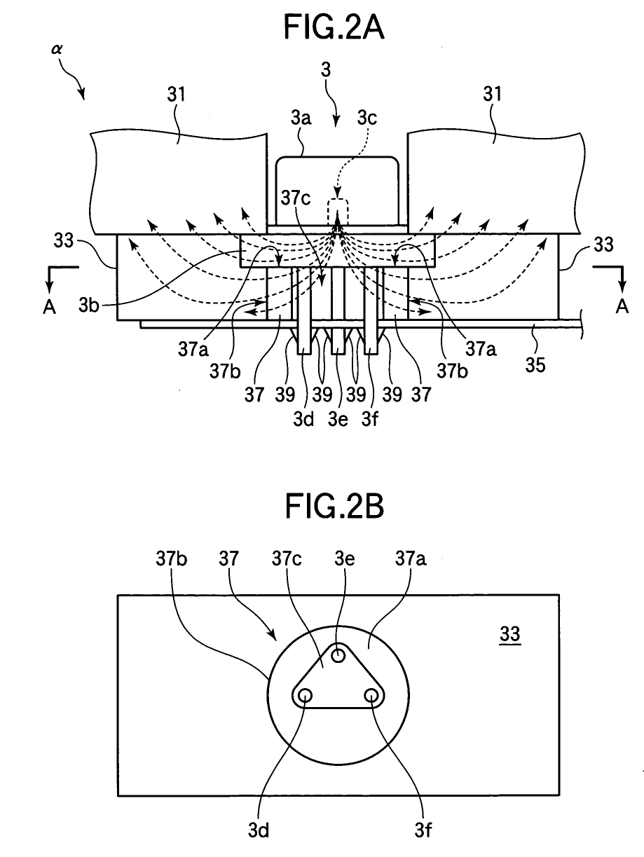

Next, a heat-conducting member according to this embodiment and an optical head using the same will be described with reference to FIGS. 2A and 2B. FIGS. 2A and 2B show a portion α of FIG. 1B under magnification. FIG. 2A shows a partial cross section of the vicinity of the laser diode 3 of the optical head 1 (the laser diode 3 is shown without being cut). In FIG. 2A, the laser diode 3 is not cut and the whole is shown. FIG. 2B shows an end face cut along line A-A of FIG. 2A. As shown in FIG. 2A, the laser diode 3 is fixed to the housing 31 of the optical head 1 by using a holder 33. A heat-conducting member 37 is disposed between a base part 3b of the laser diode 3 and an FPC 35 electrically connected to electrode terminals 3d, 3e and 3f of the laser diode 3. The heat-conducting member 37 functions to conduct heat generated in a light emitting part 3c of the laser diode 3 (heat conduction) and to release the heat to the holder 33 for holding the laser diode 3 and the housing 31.

The laser diode 3 includes the light emitting part 3c to emit a light beam to be incident on the optical recording medium 29 (not shown in FIGS. 2A and 2B), and the electrode terminals 3d, 3e and 3f connected to a power supply terminal to the light emitting part 3c and a reference potential terminal. The electrode terminals 3d, 3e and 3f are formed to project from the base part 3b with a thin plate cylindrical shape. A cap 3a covering the light emitting part 3c is fixed on the base part 3b. The cap 3a includes a not-shown emission port through which the light beam is emitted. In the laser diode 3, the cap 3a is inserted in an opening formed in the housing 31 so that the emitted light is directed toward the inside of the optical head 1. The housing 31 is made of a metal material. The holder 33 disposed from the side of the electrode terminals 3d, 3e and 3f is also made of a metal material, and an opening is formed to have such a size that the holder does not come in contact with the electrode terminal 3d and the like of the laser diode 3. The holder 33 at the contact surface side to the housing 31 is formed to be recessed by the thickness of the base part 3b. When the holder 33 on which the laser diode 3 is mounted is fixed by inserting the cap 3a in the opening of the housing 31, the base part 3b is sandwiched between the housing 31 and the holder 33. By this, the laser diode 3 is fixed to the housing 31. The holder 33 is fixed to the housing 31 by using a screw or an adhesive (neither of them is shown).

The heat-conducting member 37 is disposed to be embedded in the opening of the holder 33. A contact surface (back surface of the holder 33) of the holder 33 to the FPC 35 and a contact surface of the heat-conducting member 37 to the FPC 35 are contained in the same plane. A hollow part 37c is formed in the heat-conducting member 37, and the electrode terminals 3d, 3e and 3f are inserted in the hollow part 37c and project from the opening of the holder 33. The electrode terminals 3d, 3e and 3f projecting from the opening of the holder 33 are soldered to the FPC 35 by solders 39. By this, the laser diode 3 is connected to the power supply circuit (not shown) through the FPC 35. At the time of soldering, in the case where heat of a soldering iron is diffused through the heat-conducting member 37 and the workability of soldering is poor, the FPC 35 with a glass epoxy substrate having high heat insulation effectiveness may be used.

As shown in FIGS. 2A and 2B, the heat-conducting member 37 is made of an insulating material to have a thin plate cylindrical shape. The heat-conducting member 37 is made of, for example, aluminum nitride (AlN) of ceramic material as the insulating material by using a general sintering method. Besides, the heat-conducting member 37 includes a first contact part 37a in thermal contact with a plane of the base part 3b (back surface of the base part 3b) at the side of the FPC 35 and a second contact part 37b in thermal contact with a side wall of the opening of the holder 33.

The size of the heat-conducting member 37 is formed to be contained in a space surrounded by the back surface of the base part 3b, the surface of the FPC 35 opposite to the back surface of the base part 3b, and the side wall of the holder 33. In general, the base part 3b of the laser diode 3 is plated with gold. Since gold is relatively soft, when a certain degree of pressure is applied, the adhesiveness is raised. Thus, when the housing 31 and the holder 33 are used to apply pressure to the laser diode 3 toward the heat-conducting member 37 side, the adhesiveness of the back surface of the base part 3b and the first contact part 37a can be raised.

In the case where the pressure can not be applied due to circumstances such as the strength of the housing 31 and the holder 33, when a heat conductive resin is applied and a treatment to fill a minute gap is performed, there is also a case where a better effect can be obtained. Since the amount of the resin to be applied is very small, when one which does not generate a corrosive gas at the time of hardening (for example, heat hardening) is used, various problems described in the related art do not arise.

The one hollow part 37c of the heat-conducting member 37 is formed so as to surround the electrode terminals 3d, 3e and 3f. The electrode terminals 3d and 3f are disposed on a plane including a center axis of the base part 3b and are opposite to each other while a predetermined interval is provided with respect to the center axis, and the electrode terminal 3e is disposed on a plane including the center axis and orthogonal to the former plane while a predetermined interval from the center axis is provided. Thus, the hollow part 37c is formed into a hollow triangular prism shape so as to collectively surround the three electrode terminals 3d, 3e and 3f.

Next, heat conduction by the heat-conducting member 37 will be described. The thermal conductivity of AlN of the heat-conducting member 37 is about 100 to 200 (W/m·K). Accordingly, AlN has the thermal conductivity several thousand times as high as the air. Thus, when the heat-conducting member 37 is embedded in the opening of the holder 33 while thermal contact with the base part 3b and the holder 33 is ensured, as indicated by arrows of broken lines in FIG. 2A, heat generated in the light emitting part 3c is conducted through the base part 3b to the holder 33 and the housing 31, flows from the first contact part 37a into the heat-conducting member 37 through the back surface of the base part 3b, flows out of the second contact part 37b, and is conducted to the holder 33. As stated above, by disposing the heat-conducting member 37 at the back surface of the base part 3b, as compared with the conventional optical head 101, paths to conduct the heat generated in the light emitting part 3c to the holder 33 and the housing 31 can be increased, and the heat can be sufficiently released.

Instead of AlN, silicon carbide (SiC) or silicon nitride (Si₃N₄) may be used as the formation material of the heat-conducting member 37. The thermal conductivity of SiC is approximately 200 to 260 (W/m·k), and the thermal conductivity of Si₃N₄ is approximately 25 to 100 (W/m·K). Accordingly, the heat-conducting member 37 made of these materials can sufficiently conduct the heat generated in the laser diode 3 to the holder 33 and the housing 31.

As described above, according to this embodiment, the optical head 1 includes the heat-conducting member 37 made of the insulating material having the thermal conductivity higher than the air, and as compared with the conventional optical head 101, the paths to guide the heat generated in the laser diode 3 to the holder 33 and the housing 31 can be increased, and therefore, the heat can be sufficiently released. Besides, since the heat-conducting member 37 can be disposed to be closer to the heat generating part (light emitting part 3c) of the laser diode 3 than the housing 31, the heat can be efficiently conducted to the holder 33 and the housing 31. By this, the heat radiation of the optical head 1 is raised, the temperature rise of the laser diode 3 can be prevented, various characteristics such as optical characteristics, electric characteristics and the like of the laser diode 3 are stabilized, and the lifetime can be prolonged.

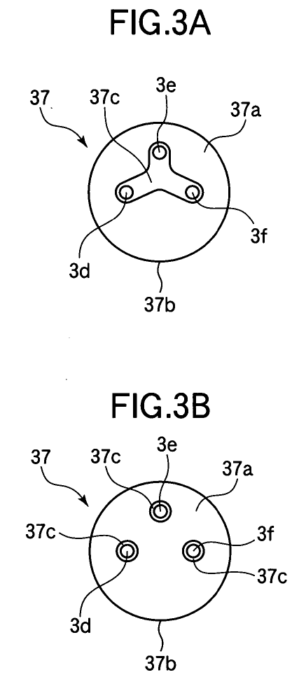

Next, modified examples of this embodiment will be described with reference to FIGS. 3A and 3B. FIGS. 3A and 3B show states in which heat-conducting members 37 according to first and second modified examples are seen from the first contact part 37a side. FIG. 3A shows the heat-conducting member 37 of the first modified example. FIG. 3B shows the heat-conducting member 37 of the second modified example. In FIGS. 3A and 3B, for facilitating understanding, electrode terminals 3d, 3e and 3f are also shown.

As shown in FIG. 3A, the heat-conducting member 37 of the first modified example is characterized in that the section of a hollow part 37c is formed into a reversed-Y shape in the drawing. The hollow part 37c is formed by extending to the electrode terminals 3d, 3e and 3f from almost the center part of an imaginary triangle with the electrode terminals 3d, 3e and 3f as the apexes. The sectional area of the hollow part 37c of this modified example can be made smaller than the sectional area of the hollow part 37c of the above embodiment. By this, the contact area between the first contact part 37a and the back surface of the base part 3b can be made large, and the heat radiation effect can be improved more than the above embodiment.

As shown in FIG. 3B, the heat-conducting member 37 of the second modified example is characterized by including three hollow parts 37c respectively formed to surround the electrode terminals 3d, 3e and 3f. The inner diameter of the hollow parts 37c are formed to be slightly larger than the outer diameter of each of the electrode terminals 3d, 3e and 3f. Thus, the sectional area of the hollow part 37c of this modified example can be made smaller than the sectional area of the hollow part 37c of the above embodiment and the first modified example. By this, the contact area between the first contact part 37a and the back surface of the base part 3b can be made large. Further, since the hollow part 37c can be made closer to the electrode terminals 3d, 3e and 3f, the heat radiation effect can be improved more than the above embodiment and the first modified example.

In the heat-conducting member 37 of the above embodiment, and the first and the second modified examples, the hollow part 37c is formed not to come in contact with the electrode terminals 3d, 3e and 3f. However, since the heat-conducting member 37 is made of the insulating material, even if the hollow part 37c is formed so that the heat-conducting member 37 comes in contact with the electrode terminals 3d, 3e and 3f, the electrode terminals 3d, 3e and 3f are not short-circuited to each other. When the heat-conducting member 37 is brought into contact with the electrode terminals 3d, 3e and 3f, the heat radiation effect can be further improved.

### Embodiment 1-2

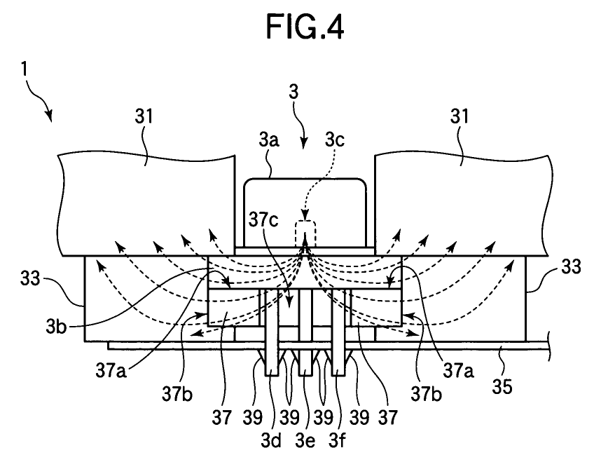

Next, a heat-conducting member according to embodiment 1-2 of the invention and an optical head using the same will be described with reference to FIG. 4. FIG. 4 shows a partial cross section of the vicinity of a laser diode 3 of an optical head 1 (the laser diode 3 is shown without being cut) according to this embodiment. The optical head 1 of this embodiment is characterized in that a heat-conducting member 37 is held between a base part 3b and a holder 33. As shown in FIG. 4, the holder 33 of this embodiment is formed to be recessed by the thickness of the heat-conducting member 37 and the base part 3b so that when the heat-conducting member 37 and the laser diode 3 are inserted in an opening, a plane of the base part 3b at a cap 3a side (surface of the base part 3b) is contained in the same plane as a contact surface of the holder 33 to a housing 31. The hole bored in the holder 33 at the contact surface side to the housing 31 is slightly larger than the outer diameter of the base part 3b, and the hole bored in the back side of the holder 33 is smaller than the outer diameter of the base part 3b.

The outer diameter of the heat-conducting member 37 is formed to be almost equal to the outer diameter of the base part 3b, so that it comes in thermal contact with the side wall of the opening of the holder 33 and is held at the back surface side of the holder 33. When the laser diode 3 is held by the holder 33 and the housing 31, the heat-conducting member 37 is pressed by the base part 3b and the holder 33, and the adhesiveness between the back surface of the base part 3b and a first contact part 37a can be raised.

### Embodiment 1-3

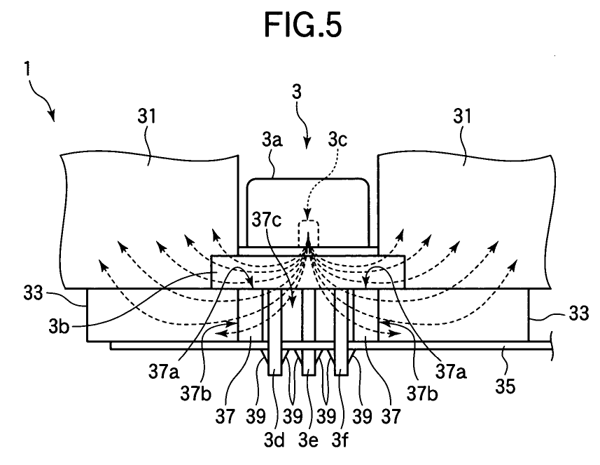

Next, a heat-conducting member according to embodiment 1-3 and an optical head using the same will be described with reference to FIG. 5. FIG. 5 shows a partial cross section of the vicinity of a laser diode 3 of an optical head 1 according to this embodiment (the laser diode 3 is shown without being cut). The optical head 1 of this embodiment is characterized in that a housing 31 at a contact surface side to a holder 33 is formed to be recessed by the thickness of a base part 3b. As shown in FIG. 5, since the housing 31 of this embodiment at the contact surface side to the holder 33 is formed to be recessed by the thickness of the base part 3b, when the laser diode 3 is fitted in the housing 31, the contact surface of the housing 31 to the holder 33 and the back surface of the base part 3b are contained in the same plane. Thus, by disposing the holder 33 having an opening with an inner diameter smaller than the outer diameter of the base part 3b, the laser diode 3 is held by the housing 31 and the holder 33. Besides, when a heat-conducting member 37 is embedded in the opening of the holder 33, and an FPC 35 is soldered to electrode terminals 3d, 3e and 3f, the heat-conducting member 37 is held between the base part 3b and the FPC 35. Since the heat-conducting member 37 can ensure thermal contact with the base part 3b and the holder 33, the same effects as the above embodiment can be obtained.

Next, a modified example of this embodiment will be described. In this embodiment, the heat-conducting member 37 is made of the ceramic material. On the other hand, this modified example is characterized in that the heat-conducting member 37 is made of silicone rubber. The heat-conducting member 37 of this modified example is formed such that a low hardness heat radiation resin, for example, silicone rubber containing an inorganic filler or the like to raise heat conductivity is formed into a sheet, and is formed into almost the same shape as the heat-conducting member 37 of the above embodiment. The heat-conducting member 37 is pierced with electrode terminals 3d, 3e and 3f of the laser diode 3 and can be attached while being brought into contact with the laser diode 3. Further, in this case, since the heat-conducting member 37 can be brought into contact with the electrode terminals 3d, 3e and 3f close to the heat generating part, the heat radiation effect can be raised. Since a hollow part 37c is formed by piercing the heat-conducting member 37 with the laser diode 3, the hollow part 37c may not be formed in the heat-conducting member 37 in advance.

The thermal conductivity of silicone rubber is approximately 1 to 6 (W/m·K) and is lower than the thermal conductivity of the ceramic material used in the above embodiment. However, the thermal conductivity of silicone rubber is several tens to several hundred times as high as the thermal conductivity of the air. Thus, when the heat-conducting member 37 is made of silicone rubber, and the thermal contact with the back surface of the base part 3b and the side wall of the opening of the holder 33 is ensured, heat generated in the laser diode 3 is conducted and can be released to the holder 33 and the housing 31. Besides, since silicone rubber is a material having flexibility, as compared with the heat-conducting member 37 made of AlN, the adhesiveness to the base part 3b and the holder 33 can be raised. By this, in the heat-conducting member 37 of this modified example, the same effects as the above embodiment can be obtained. Incidentally, the heat-conducting member 37 of this modified example can also be used for the heat-conducting member 37 of the embodiments 1-1 and 1-2.

Embodiments 2-1 to 2-4 of the invention relate to a laser diode attachment auxiliary member for attaching a laser diode to a housing of an optical head, an optical head using the same, and an optical recording/reproducing apparatus using the same.

### Embodiment 2-1

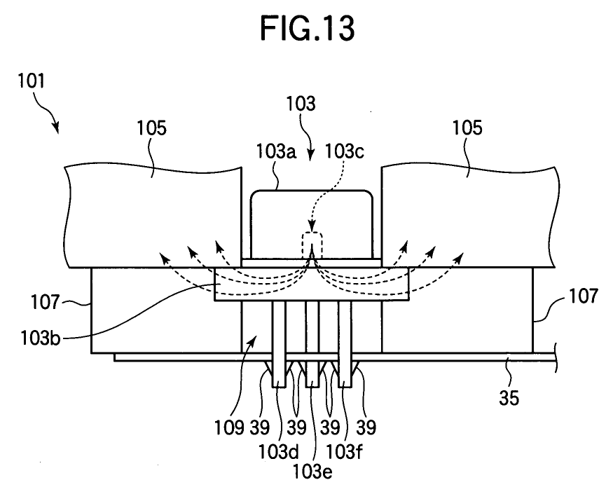

In the conventional optical head 101 shown in FIG. 13, the holder 107 and the housing 105 function also as a heat sink to release the heat generated from the laser diode 103. Especially in the recordable optical head 101, since a high intensity optical beam is generated at the time of recording, heat quantity from the laser diode 103 is large, and importance is given to the thermal conductivity so that metal material is used for the holder 107 or the housing 105. Also in the laser diode 103, the light emitting part 103c as the heat generating part is provided on the mount integrated with the base part 103b of the metal material, and heat is efficiently conducted to the base part 103b. Since the metal material is conductive material, the holder 107 and the housing 105 have such shape and structure that they are in contact with the laser diode 103 through only the cap 103a and the base part 103b, and are not in contact with the electrode terminal 103d and the like. In general, the electrode terminal 103d and the like is formed to be very close to the light emitting part 103c as the heat generating part of the laser diode 103.

As stated above, the opening 109 having a sufficient size is provided in the holder 107 so that the holder 107 does not come in contact with the electrode terminal 103d or the like. Besides, in order that the laser diode 103 is not damaged by heat at the time of soldering to the FPC 35, a predetermined gap is provided between the base part 103b and the FPC 35. Most of the heat generated in the light emitting part 103c is released from the base part 103b. However, the opening 109 is a cavity and is filled with the air. The thermal conductivity of the air is as very small as 0.0241 (W/m·K) at 0° C. Thus, as indicated by the arrows of broken lines in FIG. 13, the heat generated in the light emitting part 103c is conducted to the holder 107 and the housing 105 through the side surface of the base part 103b, and the heat conducted to the holder 107 through the opening 109 is very small.

Besides, the heat conducted to the housing 105 is transmitted to a mechachassis of an optical recording/reproducing apparatus and is released to the air. However, the respective connection parts of the base part 103b, the holder 107 and the housing 105 have contact thermal resistance, the quantity of heat which can be conducted by those members is limited, and further, as the output of the laser diode 103 is increased, there is a tendency that the quantity of heat generated increases. Besides, as the recording/reproducing speed is increased in recent years, a laser driver IC comes to be mounted on the housing 105 so that laser diode supply power of high frequency does not deteriorate in a long transmission path, and therefore, heat from this IC is also conducted to the housing 105. Thus, the heat radiation of the optical head 101 and the optical recording/reproducing apparatus is reaching the limit.

On the other hand, since the thermal emissivity of copper (Cu) or aluminum (Al) as the formation material of the housing 105 or the holder 107 is less than 0.1 at 100° C. and is very small, there is little radiation of heat from the housing 105 or the holder 107 to the air. Thus, a large fin is provided, or the surface area of the housing 105 is increased to improve heat radiation by air convection. However, since the space is limited, this is also limited.

As stated above, since the path of heat conduction is limited, and the heat radiation of the optical head 101 is limited, the heat generated in the light emitting part 103c is not sufficiently released but is retained. As a result, various characteristics such as optical characteristics and electric characteristics of the laser diode 103 are changed, so that the performance of the optical head 101 is deteriorated, and an erroneous operation of the laser driver IC is caused, and further, the lifetime of the optical head is shortened.

Patent document 2 discloses a heat radiator to cool a laser diode as a light source of an optical head, and discloses the heat radiator in the optical head characterized in that a metal laser holder which holds the laser diode and incorporates it in a housing, and a heat radiation coating material having heat radiation action is applied to a first and a second heat radiation plates. However, since the heat radiator is merely such that the heat radiation coating material is applied to the laser holder, and the first and the second heat radiation plates, there is a possibility that a sufficient heat radiation effect can not be obtained for high temperature heat generated in a high output laser diode.

Besides, the application of a suitable amount of heat radiation coating material to a suitable range is poor in workability, it takes a predetermined time to dry the heat radiation coating material, and the working time becomes long. Further, fears about the durability of the coating are caused by the application itself of the heat radiation coating material to the portion the temperature of which rapidly rises, and then, which is subjected to high temperature, and there is a high risk that flakes of the coating cause trouble in the optical recording/reproducing apparatus.

An object of this embodiment is to provide a laser diode attachment auxiliary member to efficiently conduct heat generated in a laser diode and to release the heat.

Besides, another object of this embodiment is to provide an optical head in which various characteristics such as optical characteristics and electric characteristics are stabilized, and the lifetime of a laser diode can be prolonged, and an optical recording/reproducing apparatus using the same.

The above object is achieved by a laser diode attachment auxiliary member for attaching a laser diode to a housing of an optical head, which is made of an insulating material.

The laser diode attachment auxiliary member of the embodiment is characterized in that the insulating material includes at least a ceramic material.

The laser diode attachment auxiliary member of the embodiment is characterized in that the ceramic material is aluminum nitride.

The laser diode attachment auxiliary member of the embodiment is characterized in that the ceramic material is silicon carbide.

It is characterized in that the laser diode attachment auxiliary member of the embodiment includes a first contact part in thermal contact with a base part of the laser diode, a second contact part in thermal contact with the housing, and a hollow part formed in vicinities of electrode terminals to surround the electrode terminals projecting from the base part.

It is characterized in that the laser diode attachment auxiliary member of the embodiment includes a third contact part in thermal contact with air.

The laser diode attachment auxiliary member of the embodiment is characterized in that the hollow part is formed to collectively surround the plural electrode terminals projecting from the base part.

The laser diode attachment auxiliary member of the embodiment is characterized in that the hollow part is formed to surround each of the plural electrode terminals projecting from the base part.

It is characterized in that the laser diode attachment auxiliary member of the embodiment is used for position adjustment of the laser diode and the housing.

Besides, the above object is achieved by an optical head including a laser diode to emit a laser light to an optical recording medium, a housing to fix the laser diode, and a laser diode attachment auxiliary member made of an insulating material and for attaching the laser diode to the housing.

The optical head of the embodiment is characterized in that the laser diode attachment auxiliary member is the above-mentioned laser diode attachment auxiliary member of the invention.

The optical head of the embodiment is characterized in that the laser diode attachment auxiliary member is in thermal contact with a vicinity of a heat generating part of the laser diode.

Besides, the above object is achieved by an optical recording/reproducing apparatus including the optical head of the above embodiment.

It is characterized in that the optical recording/reproducing apparatus of the above embodiment includes a heat absorbing member to receive heat radiated from the laser diode attachment auxiliary member.

According to this embodiment, since the laser diode attachment auxiliary member excellent in heat radiation and heat conduction is used, the optical head and the optical recording/reproducing apparatus using the same can be realized in which heat generated in the laser diode is sufficiently released, the original performance can be exhibited in various characteristics such as optical characteristics and electric characteristics of the laser diode, and the lifetime is prolonged.

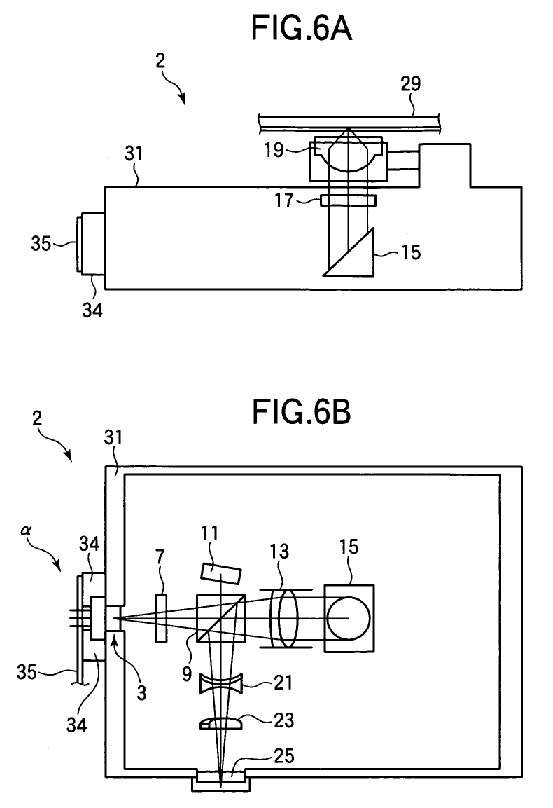

A laser diode attachment auxiliary member according to embodiment 2-1 of the invention and an optical head using the same will be described with reference to FIGS. 6A to 8B. First, a rough structure of an optical head according to this embodiment will be described with reference to FIGS. 6A and 6B. FIG. 6A shows an optical head 2 according to this embodiment and a part of an optical recording medium 29, and shows a section cut by a plane orthogonal to an information recording surface of the optical recording medium 29 and parallel to a tangential direction of a truck of the optical recording medium 29. For facilitating understanding, arising mirror 15 and a quarter wavelength plate 17 are transparently shown, which are disposed in a housing 31 and can not be originally seen. FIG. 6B shows a state in which a laser diode 3 and an optical system disposed in the housing 31 are seen in a direction vertical to the information recording surface of the optical recording medium 29, and for facilitating understanding, the quarter wavelength plate 17 disposed in the housing 31 is omitted in the drawing.

The structure and operation of an optical element group will be described with reference to FIGS. 6A and 6B. A light beam emitted from the laser diode 3 as a light source passes through a diffraction grating 7 and is converted into three beams for tracking error detection, and they are incident on a beam splitter 9. The beam splitter 9 has such polarization characteristics that 90% or more of light of P polarization is transmitted, and almost 100% of light of S polarization is reflected. The outward light beam in this embodiment has the P polarization, and most of it passes through the beam splitter 9, and several % of reflected light is incident on a front monitor optical detector 11, and the output of the laser diode 3 is controlled based on its output.

Most of the light beam having passed through the beam splitter 9 is incident on a collimate lens 13. The collimate lens 13 can be moved in the direction parallel to the optical axis. In the case where a spherical aberration added to the light beam condensed on the information recording surface of the optical recording medium 29 is different from a reference value by the thickness of the light transmission layer of the optical recording medium 29, the collimate lens 13 is moved in the optical axis direction, so that the spherical aberration can cancel out.

The light beam after transmission through the collimeter lens 13 is reflected by the rising mirror 15, and its optical path is bent toward the direction of the optical recording medium 29, and further, the light beam passes through the quarter wavelength plate 17 and is made a condensed light incident on the optical recording medium 29 by an objective lens 19. The quarter wavelength plate 17 has a function to convert the outward light beam into circular polarization and to convert the light beam of the circular polarization, which has been reflected by and returned from the optical recording medium 29, into linear polarization in the direction orthogonal to the polarization direction of the outward light beam.

The light beam, which has been condensed to form a spot on the information recording surface in the optical recording medium 29 and reflected, returns in a return path to the beam splitter 9 along the same path. Since the light beam having returned to the beam splitter 9 has the S polarization by the action of the quarter wavelength plate 17, it is reflected.

The light beam after reflection is incident on a concave lens 21. At the time of assembling and adjusting the optical head 2, the concave lens 21 is moved in the optical axis direction, so that an image point position in the optical axis direction in the vicinity of a light receiving surface in an optical detector 25 as a light receiving element can be adjusted. The light beam having passed through the concave lens 21 passes through a cylindrical lens 23 so that astigmatism is given for focus error detection, and the beam is incident on the light detector 25. The concave lens 21 and the cylindrical lens 23 may be replaced with an anamorphic lens having functions of both. The light beam incident on the light detector 25 is converted into an electric signal by its inside inner light receiving part.

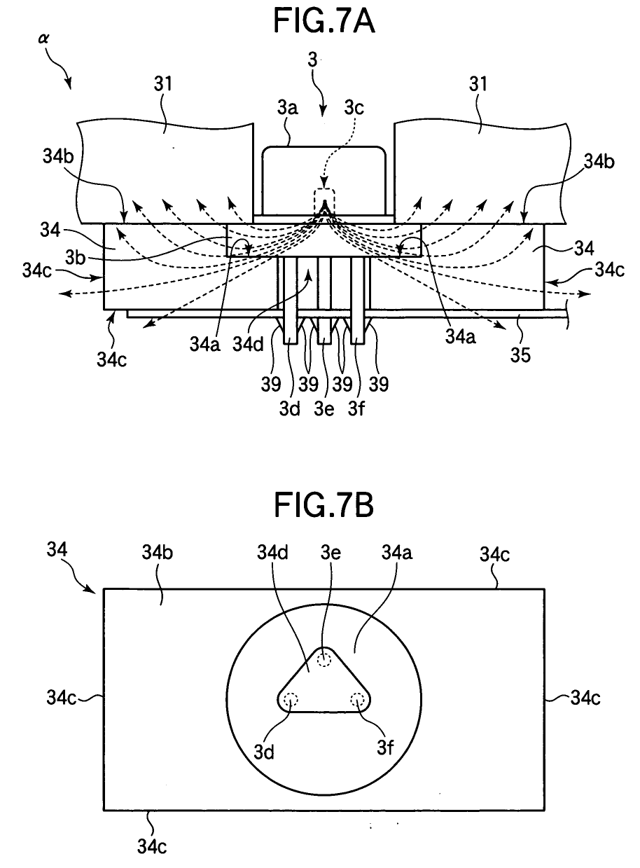

FIGS. 7A and 7B show a portion a of FIG. 6B under magnification. FIG. 7A shows a partial cross section of the vicinity of the laser diode 3 of the optical head 2 (the laser diode 3 is shown without being cut). FIG. 7B shows a surface of an attachment auxiliary member (laser diode attachment auxiliary member) 34 which is seen from the side of a first and a second contact parts 34b while the attachment auxiliary member 34 is removed from the housing 31 of the optical head 2. FIG. 7B shows electrode terminals 3d, 3e and 3f by broken lines for facilitating understanding.

As shown in FIG. 7A, the laser diode 3 is fixed to the housing 31 of the optical head 2 by using the attachment auxiliary member 34 made of an insulating material. The attachment auxiliary member 34 is disposed to be in contact with the laser diode 3, the housing 31 and the air. By this, the attachment auxiliary member 34 functions to conduct heat generated in a light emitting part 3c of the laser diode 3 (heat conduction) and to release the heat by conducting the heat to the housing 31 or by radiating the heat to the air.

The laser diode 3 includes the light emitting part 3c to emit the light beam to be incident on the optical recording medium 29 (not shown in FIG. 7A), and the electrode terminals 3d, 3e and 3f connected to a power supply terminal to the light emitting part 3c and a reference potential terminal. The electrode terminals 3d, 3e and 3f are formed to project from a base part 3b with a thin plate cylindrical shape. A cap 3a covering the light emitting part 3c is fixed on the base part 3b. The cap 3a includes a not-shown emission port through which the light beam is emitted. In the laser diode 3, the cap 3a is inserted in an opening formed in the housing 31 so that the emitted light is directed toward the inside of the optical head 2. The housing 31 is made of a metal material. In the attachment auxiliary member 34 disposed from the side of the electrode terminals 3d, 3e and 3f, a surface at the contact surface (second contact part 34b) side to the plane of the housing 31 (back surface of the housing 31) at the FPC 35 side is formed to be recessed by the thickness of the base part 3b. When the attachment auxiliary member 34 on which the laser diode 3 is mounted is fixed by inserting the cap 3a in the opening of the housing 31, the base part 3b is sandwiched between the housing 31 and the attachment auxiliary member 34. By this, the laser diode 3 is fixed to the housing 31. The attachment auxiliary member 34 is fixed to the housing 31 by using a screw or an adhesive (neither of them is shown).

A hollow part 34d is formed in the attachment auxiliary member 34, and the electrode terminals 3d, 3e and 3f are inserted in the hollow part 34d and project from the attachment auxiliary member 34. The electrode terminals 3d, 3e and 3f projecting from the attachment auxiliary member 34 are soldered to the FPC 35 by solders 39. By this, the attachment auxiliary member 34 is held between the housing 31 and the FPC 35 in a state where its part protrudes from the FPC 35. Besides, the laser diode 3 is connected to the power supply circuit (not shown) through the FPC 35. At the time of soldering, in the case where heat of a soldering iron is diffused through the attachment auxiliary member 34 and the workability of soldering is poor, the FPC 35 with a glass epoxy substrate having high heat insulation effectiveness may be used.

As shown in FIGS. 7A and 7B, the attachment auxiliary member 34 is made of, for example, an insulating material to have a thin plate rectangular solid shape. The attachment auxiliary member 34 is made of, for example, aluminum nitride (AlN) of ceramic material as the insulating material by using a general sintering method. Besides, the attachment auxiliary member 34 includes a first contact part 34a in thermal contact with a plane of the base part 3b (back surface of the base part 3b) at the side of the FPC 35 and a second contact part 34b in thermal contact with the back surface of the housing 31, and a third contact part 34c in thermal contact with the air.

The one hollow part 34d of the attachment auxiliary member 34 is formed so as to surround the electrode terminals 3d, 3e and 3f. The hollow part 34d is formed to have such a size that its side wall is disposed in the vicinities of the electrode terminals 3d, 3e and 3f. The electrode terminals 3d and 3f are disposed on a plane including a center axis of the base part 3b and are opposite to each other while a predetermined interval is provided with respect to the center axis, and the electrode terminal 3e is disposed on a plane including the center axis and orthogonal to the former plane while a predetermined interval from the center axis is provided. Thus, the hollow part 34d is formed into a hollow triangular prism shape so as to collectively surround the three electrode terminals 3d, 3e and 3f.

In general, the base part 3b of the laser diode 3 is plated with gold. Since gold is relatively soft, when a certain degree of pressure is applied, the adhesiveness is raised. Thus, when the housing 31 is used to apply pressure to the laser diode 3 toward the attachment auxiliary member 34 side, the adhesiveness of the back surface of the base part 3b and the first contact part 34a can be raised.

In the case where the pressure can not be applied due to circumstances such as the strength of the housing 31 and the attachment auxiliary member 34, when a heat conductive resin is applied and a treatment to fill a minute gap is performed, there is also a case where a better effect can be obtained. Since the amount of the resin to be applied is very small, when one which does not generate a corrosive gas at the time of hardening (for example, heat hardening) is used, various problems described in the related art do not arise.

Next, radiation of heat generated by the laser diode 3 will be described. The thermal conductivity of AlN of the attachment auxiliary member 34 is about 100 to 200 (W/m·K). Accordingly, AlN has the thermal conductivity several thousand times as high as the air. Besides, since AlN is an insulating material, even if the attachment auxiliary member 34 comes in contact with the electrode terminals 3d, 3e and 3f, there is no fear of short-circuit. Thus, the hollow part 34d is small as compared with the opening 109 of the conventional holder 107. Accordingly, as compared with the conventional optical head 101, in the optical head 2 of this embodiment, the contact area between the first contact part 34a and the back surface of the base surface 3b is large. Thus, when the attachment auxiliary member 34 is disposed while thermal contact with the base part 3b and the housing 31 is ensured, as indicated by arrows of broken lines in FIG. 7A, part of heat generated in the light emitting part 3c is conducted to the attachment auxiliary member 34 and the housing 31 through the side surface of the base part 3b, and the remaining heat flows from the first contact part 34a through the back surface of the base part 3b to the attachment auxiliary member 34. Part of the remaining heat flows out of the second contact part 34b and is conducted to the housing 31, and the residual heat is radiated from the third contact part 34c of the attachment auxiliary member 34 to the air.

The thermal emissivity of the metal material, such as Cu or Al, as the formation material of the conventional holder 107 is as very small as less than 0.1 at 100° C., and the discharge of heat energy from the surface to the air depends on almost only the convection of the air. On the other hand, in the ceramic material such as AlN, large heat energy is radiated as far-infrared rays from the surface to the air, and the heat radiation efficiency is high. The thermal emissivity of AlN is approximately 0.93, and is about 10 times as high as the thermal emissivity of Cu or Al. Accordingly, heat is easily radiated from the third contact part 34c to the air. As stated above, by using the attachment auxiliary member 34 which has the first contact part 34a with a sufficient contact area to the back surface of the base part 3b and is made of AlN having high thermal conductivity and high thermal emissivity, as compared with the conventional optical head 101, in the optical head 2, paths to conduct heat generated in the light emitting part 3c to the attachment auxiliary member 34 and the housing 31 can be increased. Further, since the attachment auxiliary member 34 can radiate the heat to the air, the optical head 2 can sufficiently release the heat generated in the light emitting part 3c.

Instead of AlN, silicon carbide (SiC), other ceramic compound or ceramic composite material may be used as the formation material of the attachment auxiliary member 34. SiC has comparable characteristics to AlN in thermal emissivity and thermal conductivity. Besides, as a material which is an insulating material and has high thermal emissivity and thermal conductivity and further has shape stability, the ceramic material is general, and among ceramic materials having high electric insulation and thermal emissivity, a material having the highest possible thermal conductivity and being excellent in moldability and strength has only to be selected. Accordingly, the attachment auxiliary member 34 made of such material conducts the heat generated in the laser diode 3 to the housing 31 or radiates it to the air and can sufficiently release the heat.

The formation material of the attachment auxiliary member 34 is selected in view of thermal conductivity and mechanical property in addition to the electric insulation and thermal emissivity. Accordingly, since the formation material of the attachment auxiliary member 34 has only to have the four properties in a balanced manner, a compound material of not ceramic materials but resin and ceramic may be used in addition to the ceramic compound and ceramic composite material.

In the case where the housing 31 of the optical head 2 is made of resin, since the thermal conductivity of the housing 31 itself is low, it becomes difficult to conduct heat from the attachment auxiliary member 34 to the housing 31. However, in this embodiment, since the heat can be released from the attachment auxiliary member 34 to the air, as compared with the conventional optical head 101, the heat generated in the light emitting part 3c can be released. As stated above, the attachment auxiliary member 34 of this embodiment is especially effective in the case where the housing 31 is made of a material having low thermal conductivity. Besides, an insulating heat release resin such as silicone grease may be applied between the attachment auxiliary member 34 and the housing.

As described above, according to this embodiment, the optical head 2 includes the attachment auxiliary member 34 made of the insulating material having high thermal emissivity and thermal conductivity, and as compared with the conventional optical head 101, the release paths of heat generated in the laser diode 3 can be increased, so that the heat can be sufficiently released. Besides, since the attachment auxiliary member 34 can be disposed to be closer to the heat generating part (light emitting part 3c) of the laser diode 3 than the housing 31, the heat can be efficiently conducted to the housing 31 and the heat can be radiated to the air. By this, the heat radiation of the optical head 2 is raised, the temperature rise of the laser diode 3 can be prevented, various characteristics such as optical characteristics and electric characteristics of the laser diode 3 can be stabilized, and the lifetime can be prolonged.

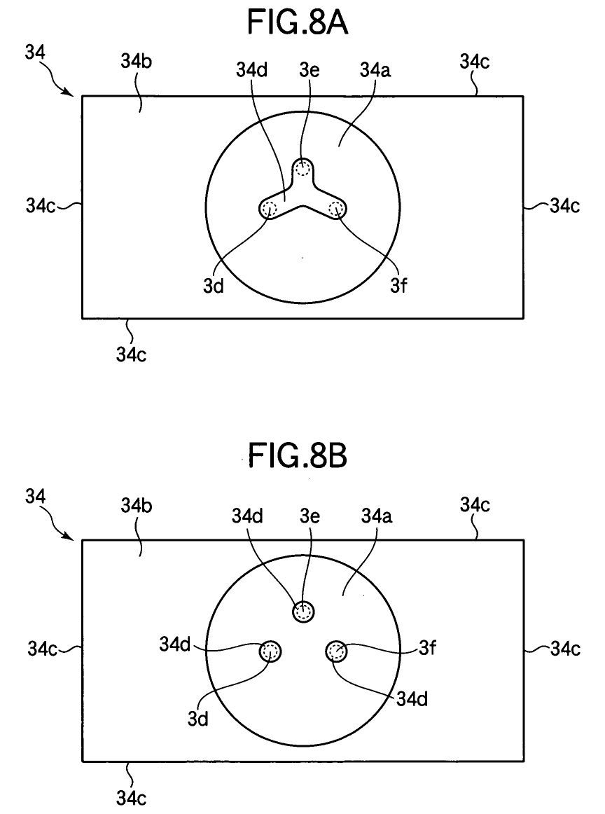

Next, modified examples of this embodiment will be described with reference to FIGS. 8A and 8B. FIGS. 8A and 8B show states in which attachment auxiliary members 34 according to a first and a second modified examples are seen from the side of a first and a second contact parts 34a and 34b. FIG. 8A shows the attachment auxiliary member 34 of the first modified example. FIG. 8B shows the attachment auxiliary member 34 of the second modified example. In FIGS. 8A and 8B, for facilitating understanding, electrode terminals 3d, 3e and 3f are also shown by broken lines.

As shown in FIG. 8A, the attachment auxiliary member 34 of the first modified example is characterized in that the section of a hollow part 34d is formed into a reversed-Y shape in the drawing. The hollow part 34d is formed by extending to the electrode terminals 3d, 3e and 3f from almost the center part of an imaginary triangle with the electrode terminals 3d, 3e and 3f as the apexes. The sectional area of the hollow part 34d of this modified example can be made smaller than the sectional area of the hollow part 34d of the above embodiment. By this, the contact area between the first contact part 34a and the back surface of the base part 3b can be made large, and the heat radiation effect can be improved more than the above embodiment.

As shown in FIG. 8B, the attachment auxiliary member 34 of the second modified example is characterized by including three hollow parts 34d respectively formed to surround the electrode terminals 3d, 3e and 3f. The inner diameter of the hollow parts 34d are formed to be slightly larger than the outer diameter of each of the electrode terminals 3d, 3e and 3f. Thus, the sectional area of the hollow part 34d of this modified example can be made smaller than the sectional area of the hollow part 34d of the above embodiment and the first modified example. By this, the contact area between the first contact part 34a and the back surface of the base part 3b can be made large. Further, since the hollow part 34d can be made closer to the electrode terminals 3d, 3e and 3f, the heat radiation effect can be improved more than the above embodiment and the first modified example. Especially, since AlN is excellent in moldability, the attachment auxiliary member 34 made of AlN as the formation material is easily formed into various shapes like the first and the second modified examples.

In the attachment auxiliary member 34 of the above embodiment, and the first and the second modified examples, the hollow part 34d is formed not to come in contact with the electrode terminals 3d, 3e and 3f. However, since the attachment auxiliary member 34 is made of the insulating material, even if the hollow part 34d is formed so that the attachment auxiliary member 34 comes in contact with the electrode terminals 3d, 3e and 3f, the electrode terminals 3d, 3e and 3f are not short-circuited to each other. When the attachment auxiliary member 34 is brought into contact with the electrode terminals 3d, 3e and 3f, the heat radiation effect can be further improved. The attachment auxiliary member 34 of the first and the second modified examples can be used as an attachment auxiliary member 34 according to embodiments 2-2 to 2-4 described below.

### Embodiment 2-2

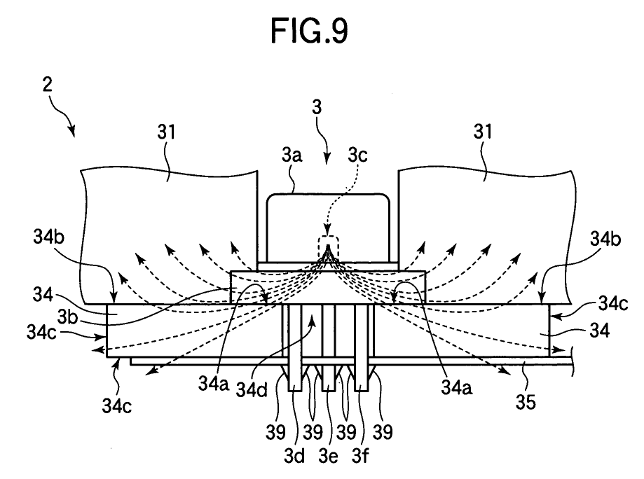

Next, a laser diode attachment auxiliary member according to embodiment 2-2 of the invention and an optical head using the same will be described with reference to FIG. 9. FIG. 9 shows a partial cross section of the vicinity of a laser diode 3 of an optical head 2 according to this embodiment (the laser diode 3 is shown without being cut). The optical head 2 of this embodiment is characterized in that the back surface of a housing 31 is formed to be recessed by the thickness of a base part 3b.

As shown in FIG. 9, since the back surface side of the housing 31 of the optical head 2 of this embodiment is formed to be recessed by the thickness of the base part 3b, when the laser diode 3 is fitted in the housing 31, the back surface of the housing 31 and the back surface of the base part 3b are contained in the same plane. Since a hollow part 34d is formed in the vicinities of electrode terminals 3d, 3e and 3f and is smaller than the outer diameter of the base part 3b, when an attachment auxiliary member 34 is disposed, the laser diode 3 is attached to the housing 31 by the attachment auxiliary member 34. A first contact part 34a can ensure thermal contact with the base part 3b, and a second contact part 34b can ensure thermal contact with the back surface of the housing 31. In the case where the base part 3b of the laser diode 3 is plated with gold, when pressure is applied to the laser diode 3 toward the housing 31 side by the attachment auxiliary member 34, adhesiveness between the back surface of the base part 3b and the first contact part 34a can be further raised.

As stated above, according to this embodiment, in the optical head 2, the back surface of the base part 3b and the first contact part 34a, the second contact part 34b and the back surface of the housing 31, and the third contact part 34c and the air can be respectively brought into thermal contact with each other, so that the same effects as the above embodiment can be obtained.

### Embodiment 2-3

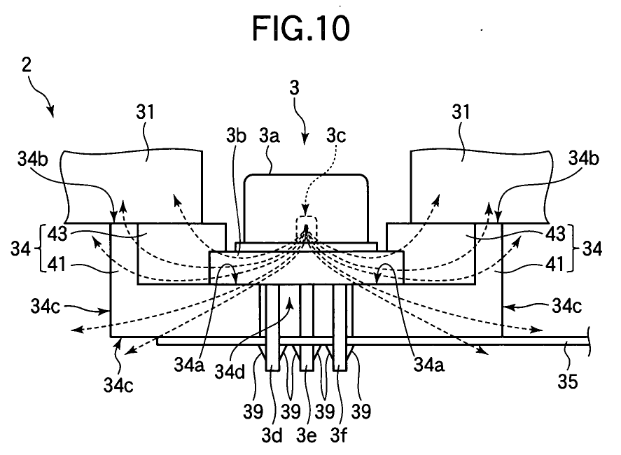

Next, a laser diode attachment auxiliary member according to embodiment 2-3 of the invention and an optical head using the same will be described with reference to FIG. 10. FIG. 10 shows a partial cross section of the vicinity of a laser diode 3 of an optical head 2 according to this embodiment (the laser diode 3 is shown without being cut). The optical head 2 of this embodiment is characterized by including an attachment auxiliary member 34 which can hold the laser diode 3 by nipping a base part 3b.

As shown in FIG. 10, the attachment auxiliary member 34 of this embodiment includes a first auxiliary member 41 disposed at a back surface side of the base part 3b and a second auxiliary member 43 disposed at a housing 31 side. The first and the second auxiliary members 41 and 43 are made of insulating material, for example, AlN of ceramic material. A plane of the second auxiliary member 43 (back surface of the second auxiliary member 43) at the side opposite to the first auxiliary member 41 is formed to be recessed by the thickness of the base part 3b. Thus, when the laser diode 3 is fitted in the second auxiliary member 43, the back surface of the second auxiliary member 43 and the back surface of the base part 3b are contained in the same plane.

A plane of the first auxiliary member 41 (face of the first auxiliary member 41) at the side opposite to the back surface of the housing 31 is formed to be recessed by the thickness of the second auxiliary member 43. The first auxiliary member 41 includes a hollow part 34d. Electrode terminals 3d, 3e and 3f are inserted in the hollow part 34d and the laser diode 3 is fitted to the second auxiliary member 43, and when the second auxiliary member 43 is mounted on and fixed to the first auxiliary member 41, the laser diode 3 is held by the first auxiliary member 41 and the second auxiliary member 43. As state above, the attachment auxiliary member 34 of this embodiment can hold the laser diode 3.

In the state where the laser diode 3 is held by the attachment auxiliary member 34, since the back surface of the second auxiliary member 43 and the back surface of the base part 3b are contained in the same plane, the contact surface of the recess part of the first auxiliary member 41 (first contact part 34a) to the base part 3b can ensure thermal contact with the base part 3b. Besides, when the second auxiliary member 43 is fixed to the first auxiliary member 41, the face of the first auxiliary member 41 and the contact surface of the second auxiliary member 43 to the housing 31 (face of the second auxiliary member 43) are contained in the same plane. By this, both the faces of the first auxiliary member 41 and the second auxiliary member 43 (second contact part 34b) can ensure thermal contact with the back surface of the housing 31. Further, the first auxiliary member 41 includes a third contact part 34c in thermal contact with the air. By this, the attachment auxiliary member 34 according to this embodiment has the same effects as the above embodiment.

Besides, since the attachment auxiliary member 34 can hold the laser diode 3, the position of the laser diode 3 can be adjusted by sliding the attachment auxiliary member 34 with respect to the housing 31 on the plane vertical to the optical axis of the laser diode 3. In this case, the slide surface of the attachment auxiliary member 34 (second contact part 34b) may be coated with an insulating heat radiation resin such as silicone grease for the purpose of raising the sliding property and thermal conductivity.

### Embodiment 2-4

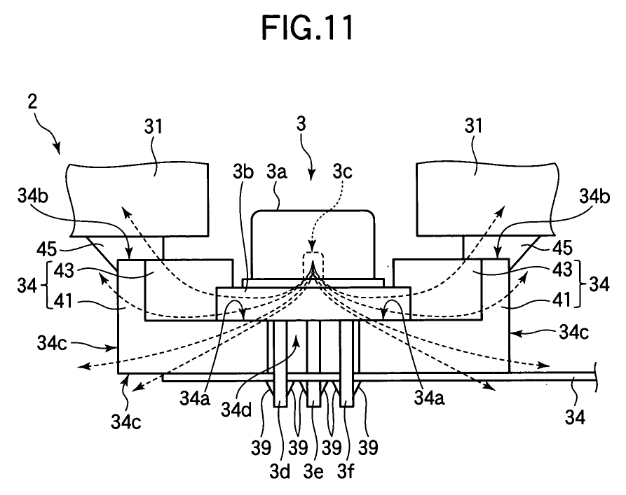

Next, a laser diode attachment auxiliary member according to embodiment 2-4 of the invention and an optical head using the same will be described with reference to FIG. 11. FIG. 11 shows a partial cross section of the vicinity of a laser diode 3 of an optical head 2 according to this embodiment (the laser diode 3 is shown without being cut). The optical head 2 of this embodiment is characterized in that an attachment auxiliary member 34 which can hold the laser diode 3 by nipping a base part 3b is included and the attachment auxiliary member 34 is fixed to a housing 31 by a resin 45.

As shown in FIG. 11, the attachment auxiliary member 34 of this embodiment has the same structure as the attachment auxiliary member 34 according to the embodiment 2-3, and includes a first auxiliary member 41 disposed at the back surface side of the base part 3b and a second auxiliary member 43 disposed at the housing 31 side. The attachment auxiliary member 34 is adhered and fixed to the housing 31 by the resin 45. A second contact part 34b of the attachment auxiliary member 34 is in thermal contact with the housing 31 through the resin 45. Besides, the attachment auxiliary member 34 is in thermal contact with the back surface of the base part 3b at a first contact part 34a, is in thermal contact with the back surface of the housing 31 at the second contact part 34b, and is in thermal contact with the air at the third contact part 34c. Accordingly, the attachment auxiliary member 34 according to this embodiment has the same effects as the above embodiment.

In the optical head 2 of this embodiment, three-dimensional adjustment (space adjustment) of the position of the laser diode 3 can be performed by using a predetermined tool to nip the attachment auxiliary member 34 and by moving it in the optical axis direction of the laser diode 3 or by inclining (tilting) it, or the position of the laser diode 3 can be adjusted by moving the attachment auxiliary member 34 with respect to the housing 31 on the plane vertical to the optical axis. After the space adjustment is performed, the attachment auxiliary member 34 is adhered and fixed to the housing 31 by the resin 45. The resin 45 with a predetermined thickness is interposed between the attachment auxiliary member 34 and the housing 31. Thus, since the attachment auxiliary member 34 does not in direct contact with the housing 31, a path of heat conducted from the attachment auxiliary member 34 to the housing 31 is limited to the resin 45.

Like the conventional optical head 101, when the holder 107 is made of metal, there is little heat radiation from the holder 107 to the air. Thus, like the optical head 2 of this embodiment, when the holder 107 is adhered and fixed to the housing 105 by the resin for the purpose of space adjustment, heat generated in the laser diode 103 is conducted from the holder 107 through the resin to the housing 105, and the path of heat conduction is very restricted. Thus, heat is retained in the holder 107.

On the other hand, the attachment auxiliary member 34 is made of the ceramic material. Thus, even if the attachment auxiliary member 34 is adhered and fixed to the housing 31 by using the resin 45 for the space adjustment of the laser diode 3, heat generated in the laser diode 3 is conducted from the attachment auxiliary member 34 through the resin 45 to the housing 31, and is further radiated to the air from the third contact part 34c, and accordingly, the heat can be efficiently released. As stated above, the attachment auxiliary member 34 is very effective in the optical head 2 of this embodiment aiming at the space adjustment.

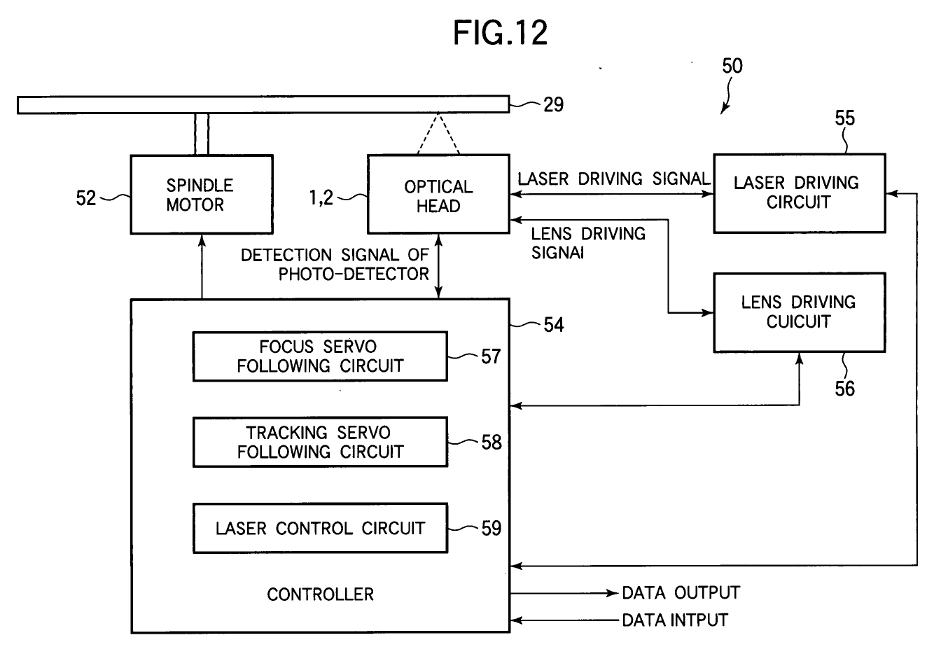

Next, an optical recording/reproducing apparatus in which the optical head 1 according to the embodiments 1-1 to 1-3 or the optical head 2 according to the embodiments 2-1 to 2-4 is mounted will be described with reference to FIG. 12. FIG. 12 shows a rough structure of an optical recording/reproducing apparatus 50 in which the optical head 1 or the optical head 2 according to the embodiment is mounted. As shown in FIG. 12, the optical recording/reproducing apparatus 50 includes a spindle motor 52 to rotate an optical recording medium 29, the optical head 1 or the optical head 2 to emit a laser beam to the optical recording medium 29 and to receive reflected light, a controller 54 to control the operation of the spindle motor 52 and the optical head 1 or the optical head 2, a laser driving circuit 55 to supply a laser driving signal to the optical head 1 or the optical head 2, and a lens driving circuit 56 to supply a lens driving signal to the optical head 1 or the optical head 2.

The controller 54 includes a focus servo following circuit 57, a tracking servo following circuit 58 and a laser control circuit 59. When the focus servo following circuit 57 operates, there occurs a state where an information recording surface of the rotating optical recording medium 29 is in focus, and when the tracking servo following circuit 58 operates, a spot of a laser beam is placed in an automatic following state with respect to an eccentric signal track of the optical recording medium 29. The focus servo following circuit 57 and the tracking servo following circuit 58 are respectively provided with an automatic gain control function to automatically adjust a focus gain and an automatic gain control function to automatically adjust a tracking gain. The laser control circuit 59 is a circuit for generating the laser driving signal supplied by the laser driving circuit 55, and generates the suitable laser driving signal based on the recording condition setting information recorded on the optical recording medium 29. The laser driving circuit 55 is often directly attached to the optical head 1 or the optical head 2.

It is not necessary that the focus servo following circuit 57, the tracking servo following circuit 58 and the laser control circuit 59 are circuits incorporated in the controller 54, and they may be separate parts from the controller 54. Further, it is not necessary that these are physical circuits, and they may be software executed in the controller 54.

The optical recording/reproducing apparatus 50 in which the optical head 2 according to the embodiments 2-1 to 2-4 is mounted includes a heat absorbing member (not shown) to receive heat at the position opposite to the attachment auxiliary member 34. By this, heat generated in the laser diode 3 and radiated from the attachment auxiliary member 34 is efficiently transmitted to the optical recording/reproducing apparatus 50. The optical recording/reproducing apparatus 50 itself has a sufficiently large heat capacity, and heat radiation to the outside from the optical recording/reproducing apparatus 50 is also performed.

The invention is not limited to the above embodiments, but can be variously modified.

Although the heat-conducting member 37 of the above embodiments 1-1 to 1-3 is formed into the thin plate cylindrical shape, the invention is not limited to this. For example, as long as the heat-conducting member 37 can come in thermal contact with the base part 3b and the holder 33, even if the shape is a thin plate prismatic shape with a hollow part 37c, the same effects as the above embodiments can be obtained.

Besides, the shape of the laser diode 3 as the light source is not limited to the embodiments 1-1 to 1-3. For example, even if the laser diode 3 is integrated with a light receiving element or an optical element, the same effects as the above embodiments can be obtained.

Besides, although the heat-conducting member 37 of the above embodiments 1-1 to 1-3 is made of the ceramic material or silicone rubber material, the invention is not limited to this. For example, a sheet-like silicone rubber may be held between the heat-conducting member 37 of the ceramic material and the base part 3b. In this case, since the adhesiveness between the heat-conducting member 37 and the base part 3b can be raised by the flexibility of the silicone rubber, the same effects as the above embodiments can be obtained.

Besides, although the first contact part 37a of the above embodiments 1-1 to 1-3 is a plane, and the second contact part 37b is a curved surface, the invention is not limited to this. For example, as long as the first contact part 37a can come in contact with the back surface of the base part 3b, the shape may be a plane, a curved surface, or a shape imitating the back surface of the base part 3b. Besides, as long as the second contact part 37b can come in contact with the side wall of the opening of the holder 33, the shape may be a plane, a curved surface, or a shape imitating the side wall of the opening of the holder 33. Also in these cases, the same effects as the above embodiments can be obtained.

Besides, although the attachment auxiliary member 34 of the above embodiments 2-1 and 2-2 is formed into the thin plate rectangular solid shape, the invention is not limited to this. For example, as long as the attachment auxiliary member 34 can come in thermal contact with the base part 3b, even if the shape is a thin plate cylindrical shape with the hollow part 34d, the same effects as the above embodiments can be obtained.

Besides, the shape of the laser diode 3 as the light source is not limited to the above embodiments 2-1 and 2-2. For example, even if the laser diode 3 is integrated with a light receiving element or an optical element, the same effects as the above embodiments can be obtained.

Besides, in the optical head 2 of the above embodiments 2-1 and 2-2, although the attachment auxiliary member 34 is in direct contact with the back surface of the base part 3b, the invention is not limited to this. For example, a sheet-like silicone rubber may be put between the attachment auxiliary member 34 and the back surface of the base part 3b. In this case, the adhesiveness between the attachment auxiliary member 34 and the back surface of the base part 3b can be raised by the flexibility of the silicone rubber, the same effects as the above embodiments can be obtained.

Besides, although the optical head 2 of the above embodiment 2-3 and 2-4 includes the attachment auxiliary member 34 provided with the first and the second auxiliary members 41 and 43 made of the ceramic material, the invention is not limited to this. For example, as long as the first auxiliary member 41 in thermal contact with the air is made of, at least, a ceramic material, heat can be efficiently released. As stated above, in the attachment auxiliary member 34 including plural parts, as long as a portion in thermal contact with the air is an insulating material including at least a ceramic material, heat can be efficiently released.

1. A heat-conducting member made of an insulating material, comprising:
a first contact part in thermal contact with a base part of a laser diode;
a second contact part in thermal contact with a holder to hold the laser diode; and
a hollow part formed to surround electrode terminals projecting from the base part.

2. A heat-conducting member according to claim 1, wherein the insulating material is a ceramic material.

3. A heat-conducting member according to claim 1, wherein the first contact part can come in close contact with the base part.

4. A heat-conducting member according to claim 1, wherein the second contact part can come in close contact with the holder.

5. A heat-conducting member according to claim 1, wherein the hollow part is formed to collectively surround the plural electrode terminals projecting from the base part.

6. A heat-conducting member according to claim 1, wherein the hollow part is formed to surround each of the plural electrode terminals projecting from the base part.

7. An optical head comprising:
a laser diode to emit a laser light to an optical recording medium;
a housing to fix the laser diode;
a holder to hold the laser diode; and
a heat-conducting member including a first contact part in thermal contact with a base part of the laser diode, a second contact part in thermal contact with the holder, and a hollow part formed to surround an electrode terminal projecting from the base part.

8. An optical head according to claim 7, wherein the heat-conducting member is made of an insulating material.

9. An optical head according to claim 7, wherein the heat-conducting member is held between a printed circuit board electrically connected to the electrode terminal and the base part.

10. An optical head according to claim 7, wherein the heat-conducting member is held between the base part and the holder.

11. An optical head according to claim 7, wherein the heat-conducting member is in thermal contact with a vicinity of a heat generating part of the laser diode.

12. An optical recording/reproducing apparatus comprising an optical head according to claim 7.

13. A laser diode attachment auxiliary member for attaching a laser diode to a housing of an optical head, wherein
the auxiliary member is made of an insulating material.

14. A laser diode attachment auxiliary member according to claim 13, wherein
the insulating material includes at least a ceramic material.

15. A laser diode attachment auxiliary member according to claim 13, comprising:
a first contact part in thermal contact with a base part of the laser diode;
a second contact part in thermal contact with the housing; and
a hollow part formed in vicinities of electrode terminals to surround the electrode terminals projecting from the base part.

16. A laser diode attachment auxiliary member according to claim 13, comprising a third contact part in thermal contact with air.

17. A laser diode attachment auxiliary member according to claim 15, wherein
the hollow part is formed to collectively surround the plural electrode terminals projecting from the base part.

18. A laser diode attachment auxiliary member according to claim 15, wherein
the hollow part is formed to surround each of the plural electrode terminals projecting from the base part.

19. A laser diode attachment auxiliary member according to claim 13, wherein
the laser diode attachment auxiliary member is used for position adjustment of the laser diode and the housing.

20. An optical head comprising:
a laser diode to emit a laser light to an optical recording medium;
a housing to fix the laser diode; and
a laser diode attachment auxiliary member made of an insulating material and for attaching the laser diode to the housing.

21. An optical head according to claim 20, wherein
the laser diode attachment auxiliary member is made of an insulating material.

22. An optical head according to claim 20, wherein
the laser diode attachment auxiliary member is in thermal contact with a vicinity of a heat generating part of the laser diode.

23. An optical recording/reproducing apparatus comprising an optical head according to claim 20.

24. An optical recording/reproducing apparatus according to claim 23, further comprising a heat absorbing member to receive heat radiated from the laser diode attachment auxiliary member.
